(19) United States
(12) Patent Application Publication
(10) Pub. No.: US 2012/0175001 A1
(43) Pub. Date: Jul. 12, 2012

(54) LIQUID CHEMICAL DISCHARGE VALVE AND LIQUID CHEMICAL SUPPLY SYSTEM

(75) Inventors: Yoshifumi NISHIO, Komaki-shi (JP); Shoji AZUMA, Komaki-shi (JP); Toshiki MURATA, Komaki-shi (JP); Nobuya SUZUKI, Komaki-shi (JP)

(73) Assignee: CKD CORPORATION, Komaki-shi (JP)

(21) Appl. No.: 13/344,551

(22) Filed: Jan. 5, 2012

(30) Foreign Application Priority Data
Jan. 12, 2011 (JP) 2011-003828

(51) Int. Cl. F16K 47/08; D06F 39/08

(52) U.S. Cl. 137/625.33; 137/312

(57) ABSTRACT

A liquid chemical discharge valve which includes a diaphragm valve having a contact portion for varying that varies a flow condition between the liquid chemical supply port and the liquid chemical discharge port by manipulating a lift amount, which is a distance between the contact portion and one of the liquid chemical supply port and the liquid chemical discharge port, between a closed valve condition and a maximum lift amount. The liquid chemical discharge valve includes an actuator unit for driving the contact portion in accordance with a supply pressure of the operating gas supplied from the operating gas supply port, to thereby manipulate the lift amount. The actuator unit includes a lift amount limiting unit for limiting the maximum lift amount adjustably.

### CROSS-REFERENCE TO RELATED APPLICATIONS

The present application claims priority based on Japan Patent Application No. 2011-003828 filed on Jan. 12, 2011, and the entire contents of that application is incorporated by reference in this specification.

### BACKGROUND OF THE INVENTION

1. Field of the Invention

The present invention relates to a liquid chemical supply system for supplying a liquid chemical using a pump, and more particularly to a liquid chemical discharge valve that supplies a liquid chemical intermittently.

2. Description of the Related Art

In a liquid chemical utilization process of a semiconductor manufacturing apparatus, various liquid chemicals, such as a photoresist liquid, supplied from a liquid chemical supply system are applied in a predetermined amount to a semiconductor wafer. In photolithography, for example, the photoresist (resist liquid), which is a photosensitive organic substance, is applied by an application method using a spin coater. A spin coater is a device that applies photoresist thinly and evenly while rotating the semiconductor wafer. A film thickness of the photoresist can be adjusted from several tens of nm to several μm by adjusting a rotation speed of the spin coater, a viscosity of the resist, a temperature environment, and so on. The liquid chemical supply system supplies the liquid chemical by drip-feeding an accurate amount of the liquid chemical onto the semiconductor wafer from a nozzle.

In liquid chemical supply methods proposed in the related art, an accurate amount of the liquid chemical is drip-fed by installing a suck back valve and adjusting a valve closing speed. A suck back valve can prevent dripping by sucking back the liquid chemical from the nozzle after the valve is closed, and therefore the problem of excessive drip-feeding due to dripping can be solved. By adjusting the valve closing speed, the generation of air bubbles in the interior of a liquid chemical flow passage caused by a water hammer phenomenon (pressure pulsation) can be suppressed, and therefore the problem of insufficient drip-feeding due to air bubbles can be solved. Meanwhile, a technique of suppressing dripping by controlling a flow rate of the liquid chemical on the basis of a preset flow rate control pattern (Japanese Patent Application Laid-open No. 2000-161514) and a technique of preventing dripping by controlling a valve closing operation of an open-close valve and a suck back operation of the suck back valve independently on the basis of separate driving signals (Japanese Patent Application Laid-open No. 2010-171295) have also been proposed. Thus, in the related art, improvements have been achieved in a discharge characteristic of the liquid chemical discharged from the nozzle. Note that Japanese Patent Application Laid-open No. H11-82763 and No. 2005-128816 also disclose fluid control valves.

However, the present inventor has newly discovered that when the amount of drip-fed liquid chemical is reduced in response to demands for reductions in the film thickness of the applied resist liquid, unevenness occurs in the thickness of the applied film even when dripping and air bubbles are not generated. The present inventor has succeeded in ascertaining the cause of this unevenness by analyzing physical characteristics of the liquid chemical discharged from the nozzle in air using a high-speed camera, rather than simply focusing on the discharge characteristic of the liquid chemical discharged from the nozzle, as in the related art.

### SUMMARY OF THE INVENTION

The present invention has been designed to solve at least a part of the problems in the related art, described above, and an object thereof is to provide a technique for reducing a drip-feeding flow rate of a liquid chemical while suppressing droplet formation.

Effective means and so on for solving the problems described above will be described below while illustrating effects and the like where necessary.

A first means is a liquid chemical discharge valve for supplying a liquid chemical onto a rotating wafer which includes a valve main body having a valve chamber formed with a liquid chemical supply port to which the liquid chemical is supplied and a liquid chemical discharge port through which the liquid chemical is discharged and a diaphragm valve having a contact portion for varying a flow condition between the liquid chemical supply port and the liquid chemical discharge port by manipulating a lift amount, which is a distance between the contact portion and one of the liquid chemical supply port and the liquid chemical discharge port, between a closed valve condition and a maximum lift amount. The liquid chemical discharge valve includes an operating gas supply unit having a first proportional control valve capable of continuously adjusting a first opening in order to manipulate a supply amount of an operating gas, a second proportional control valve capable of continuously adjusting a second opening in order to manipulate a discharge amount of the operating gas, and an operating gas supply port connected to an intermediate flow passage that connects the first proportional control valve to the second proportional control valve. The liquid chemical discharge valve includes an actuator unit for driving the contact portion in accordance with a supply pressure of the operating gas supplied from the operating gas supply port, to thereby manipulate the lift amount. The actuator unit includes a lift amount limiting unit for limiting the maximum lift amount adjustably.

In the above liquid chemical discharge valve, manipulation of the lift amount is performed by driving the contact portion of the diaphragm valve in accordance with the supply pressure of the operating gas supplied from the operating gas supply port connected to the intermediate flow passage that connects the first proportional control valve to the second proportional control valve. The first proportional control valve and the second proportional control valve are capable of continuous valve opening manipulation, and therefore pulsation occurring in a liquid chemical flow during ON/OFF operations of typically used solenoid valves can be eliminated. Accordingly, disturbances occurring in the liquid chemical flow during a valve closing operation in particular can be suppressed, leading to a reduction in droplet formation in the air due to surface tension, and as a result, the liquid chemical can be supplied in a small amount with stability.

Meanwhile, the actuator unit includes the lift amount limiting unit for limiting the maximum lift amount adjustably, and therefore the maximum lift amount can be adjusted as a lift amount for realizing a steady flow rate condition, and control of the valve closing operation can be limited to lift manipulation from the adjusted maximum lift amount to the closed valve condition. With this hardware configuration, lift manipulation stoppage in the steady flow rate condition and the valve closing operation by manipulating the lift from a fixed position (the maximum lift amount) can be usable, and therefore a stable operation having a high degree of reproducibility can be realized by implementing a simple control system. As a result, droplet formation can be reduced with a high degree of reliability, and therefore the liquid chemical can be supplied in a small amount with stability. Hence, process deterioration due to droplet formation can be suppressed easily and reliably.

The actuator unit includes both a function for manipulating the lift amount in accordance with the supply pressure of the operating gas and the lift amount limiting unit for limiting the maximum lift amount adjustably. This combination of configurations is a unique combination for preventing droplet formation occurring when the liquid chemical is supplied in a small amount by suppressing disturbances in the liquid chemical flow, and may be said to contravene the technical common knowledge of persons skilled in the art at the time of filing.

Second means is a liquid chemical supply system which includes the liquid chemical discharge valve according to the first means and a control unit for controlling a supply amount of the liquid chemical by continuously adjusting the first opening and the second opening so as to manipulate the supply pressure of the operating gas.

The control unit is configured to discharge the liquid chemical intermittently by causing the actuator unit to execute, in sequence, a closed valve maintenance operation for maintaining the closed valve condition, a valve opening operation for increasing the lift amount from the closed valve condition to the maximum lift amount, an open valve maintenance operation for maintaining the lift amount at the maximum lift amount, and a valve closing operation for reducing the lift amount from the maximum lift amount to the closed valve condition.

In this liquid chemical supply system, the liquid chemical is discharged intermittently by causing the actuator unit to execute the closed valve maintenance operation, the valve opening operation, the open valve maintenance operation, and the valve closing operation in sequence. Both the closed valve maintenance operation and the open valve maintenance operation are performed in a bottomed out condition, and therefore pulsation in the lift amount during lift amount control in the vicinity of a target value and during a transition between a state of static friction and a state of kinetic friction does not occur.

The valve opening operation and the valve closing operation are both operations that are performed by manipulating the lift amount between the closed valve condition and an open valve condition, rather than operations that require stoppage. Therefore, with this configuration, pulsation in the lift amount during lift amount control in the vicinity of a target value and during a transition between a state of static friction and a state of kinetic friction does not occur. Hence, this liquid chemical supply system is capable of discharging a liquid chemical intermittently through operations during which pulsation does not occur in the lift amount, and as a result, the liquid chemical can be supplied in a small amount with stability.

The second means is not limited to a liquid chemical supply system, and may also be realized in the form of a computer program for realizing a control function for a liquid chemical supply system and a program medium storing the program, for example.

The above and other objects, features, and advantages of the present invention will be apparent from the following description when taken in conjunction with the accompanying drawings which illustrate preferred embodiments of the present invention by way of example.

### BRIEF DESCRIPTION OF THE DRAWINGS

FIG. 1 is a circuit diagram showing a liquid chemical supply system 90 and a spin coater 60 according to this embodiment;

FIG. 2 is a sectional view showing an internal configuration of a liquid chemical discharge valve 100;

FIG. 3 is an enlarged sectional view showing an internal configuration of an air operated valve 120 in a closed condition;

FIG. 4 is an enlarged sectional view showing the internal configuration of the air operated valve 120 in an open condition;

FIG. 5 is a control block diagram of the liquid chemical discharge valve 100 according to this embodiment;

FIG. 6 is a graph showing a comparison between operating air pressures of liquid chemical discharge valves according to this embodiment and a comparative example;

FIG. 7 is a view showing a liquid chemical discharge condition photographed by a high-speed camera according to a comparative example;

FIG. 8 is a view showing a liquid chemical discharge condition photographed by a high-speed camera according to this embodiment; and

FIG. 9 is a time chart showing operating sequences of the air operated valve 120 and a suck back device 130.

### DESCRIPTION OF THE PREFERRED EMBODIMENTS

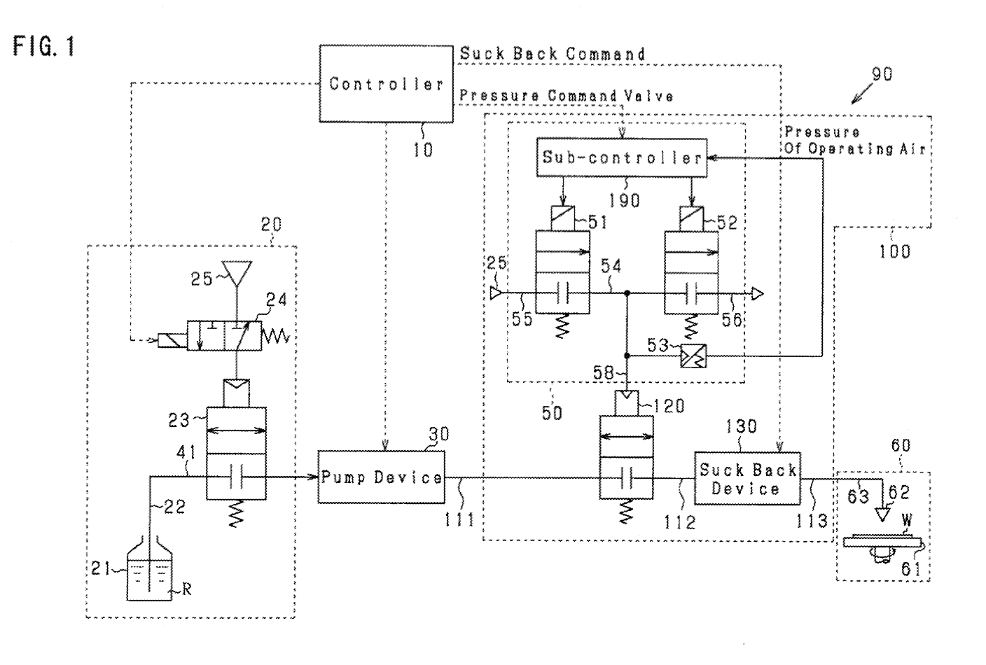

An embodiment will be described below with reference to the drawings. This embodiment is realized as a liquid chemical supply system used on a manufacturing line for a semiconductor device or the like. The liquid chemical supply system will be described on the basis of FIGS. 1 to 4. In this embodiment, a configuration for suppressing pulsation in a liquid chemical supply flow rate and a mechanism for stabilizing small-amount supply of the liquid chemical by suppressing pulsation in the liquid chemical will be described in that order.

### (Configuration of Liquid Chemical Supply System According to Embodiment)

FIG. 1 is a circuit diagram showing a liquid chemical supply system 90 and a spin coater 60 according to this embodiment. The liquid chemical supply system 90 supplies a resist liquid R serving as a liquid chemical to the spin coater 60. The spin coater 60 is a device for forming a thin film of the resist liquid R on a semiconductor wafer W. The spin coater 60 includes a turntable 61, a liquid chemical discharge nozzle 62 that supplies (drip-feeds) the resist liquid R serving as the liquid chemical onto a central position of the semiconductor wafer W placed on the turntable 61, and a liquid chemical flow passage 63 for supplying the liquid chemical to the liquid chemical discharge nozzle 62.

In this embodiment, the resist liquid R is a liquid chemical used in photolithography. Photolithography is a process for creating a fine pattern on a substrate surface coated with photoresist, which is a photosensitive organic substance, by exposing the substrate surface to a pattern shape via a photomask. In a photolithography process, an extremely thin film is formed evenly on a flat surface. The flat surface is then conveyed to an exposure device (not shown), where a fine circuit pattern is transferred onto the flat surface. From the viewpoints of environmental protection and resource saving in particular, it is desirable to use the resist liquid R efficiently during the thin film formation process in order to reduce an amount of waste liquid and conserve the resist liquid R.

The thin film formation process implemented by the spin coater 60 is as follows. The spin coater 60 rotates the semiconductor wafer W at a constant rotation speed before drip-feeding the resist liquid R. After drip-feeding the resist liquid R, the spin coater 60 increases the rotation speed so that the resist liquid R is spread over the semiconductor wafer W by centrifugal force. As a result, surplus resist liquid R is removed from the semiconductor wafer W so that an appropriate amount of the resist liquid R remains. By rotating the semiconductor wafer W further, the spin coater 60 can vaporize a solvent so that only the photosensitive organic substance is coated evenly onto the semiconductor wafer W. A film thickness of the resist can be adjusted from several tens of nm to several tm by controlling a rotation speed of the turntable 61, a viscosity of the resist, a temperature environment, and so on. The film thickness of the resist typically decreases as a rotation speed of the turntable 61 increases.

The liquid chemical supply system 90 includes a liquid chemical supply and storage device 20, a pump device 30, a liquid chemical discharge valve 100, and a controller 10 for controlling these components. The liquid chemical supply and storage device 20 includes a resist bottle 21 storing the resist liquid R, a suction pipe 22 for supplying the resist liquid R from the resist bottle 21 to the pump device 30, a suction side valve 23 for opening and closing the suction pipe 22, an operating air supply source 25 for supplying operating air to the suction side valve 23, and a pressure control valve 24 for manipulating a supply pressure of the operating air. The pressure control valve 24 is controlled by the controller 10.

The pump device 30 is a device for suctioning the resist liquid R from the suction pipe 22 of the liquid chemical supply and storage device 20 and discharging the suctioned resist liquid R to the liquid chemical discharge valve 100. The controller 10 opens the suction pipe 22 by manipulating the suction side valve 23, and applies a discharge pressure to an inlet side flow passage 111 of the liquid chemical discharge valve 100 by manipulating the pump device 30. The pump device 30 may be constituted by a diaphragm pump having a diaphragm (not shown) that is driven by operating air, for example.

The liquid chemical discharge valve 100 includes an air operated valve 120, an operating air supply unit 50, and a suck back device 130. The air operated valve 120 is a valve whose valve opening is manipulated in accordance with the supply pressure of the operating air supplied from the operating air supply unit 50. The operating air supply unit 50 supplies operating air to the air operated valve 120.

The operating air supply unit 50 includes a first proportional control valve 51, a second proportional control valve 52, a pressure sensor 53, and a sub-controller 190. The first proportional control valve 51 is connected to the operating air supply source 25 via an operating air supply flow passage 55 and connected to the air operated valve 120 via an operating air intermediate flow passage 54. The second proportional control valve 52 is connected to the air operated valve 120 via the operating air intermediate flow passage 54 and connected to an operating air discharge port via an operating air discharge flow passage 56. The pressure sensor 53 is connected to the operating air intermediate flow passage 54 to measure the supply pressure of the operating air supplied to the air operated valve 120.

The suck back device 130 is a device for preventing the resist liquid R from dripping when the air operated valve 120 is closed. The suck back device 130 includes an air operated valve (not shown), and a device (not shown) for supplying operating air to the air operated valve.

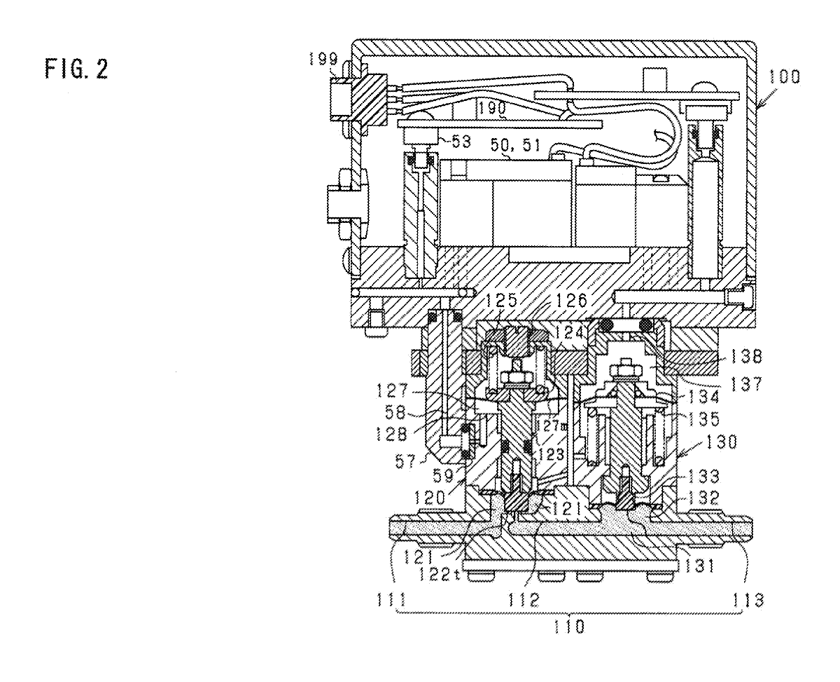

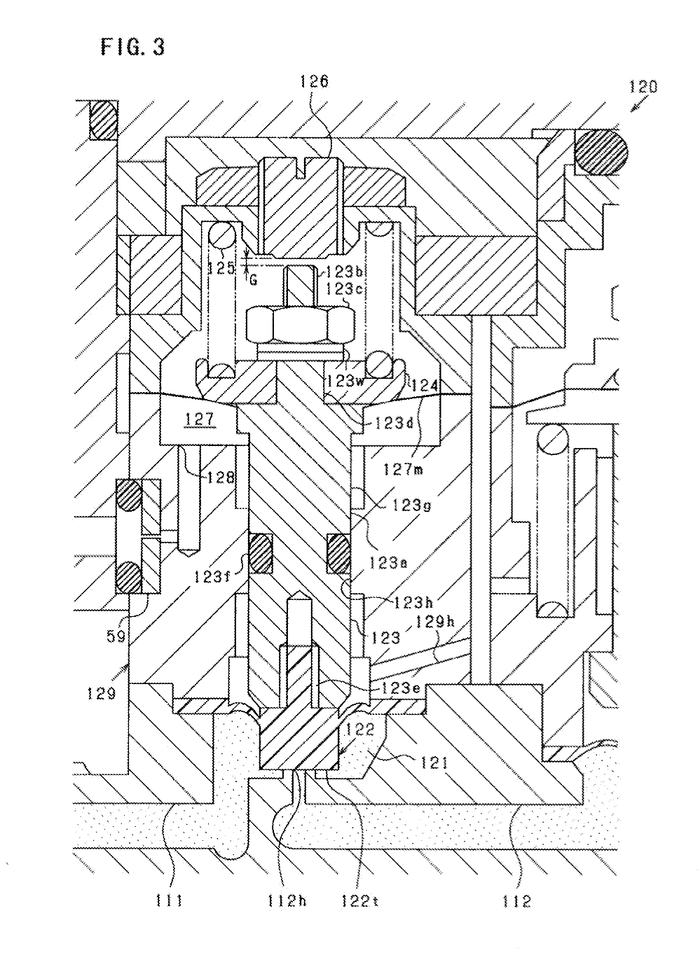

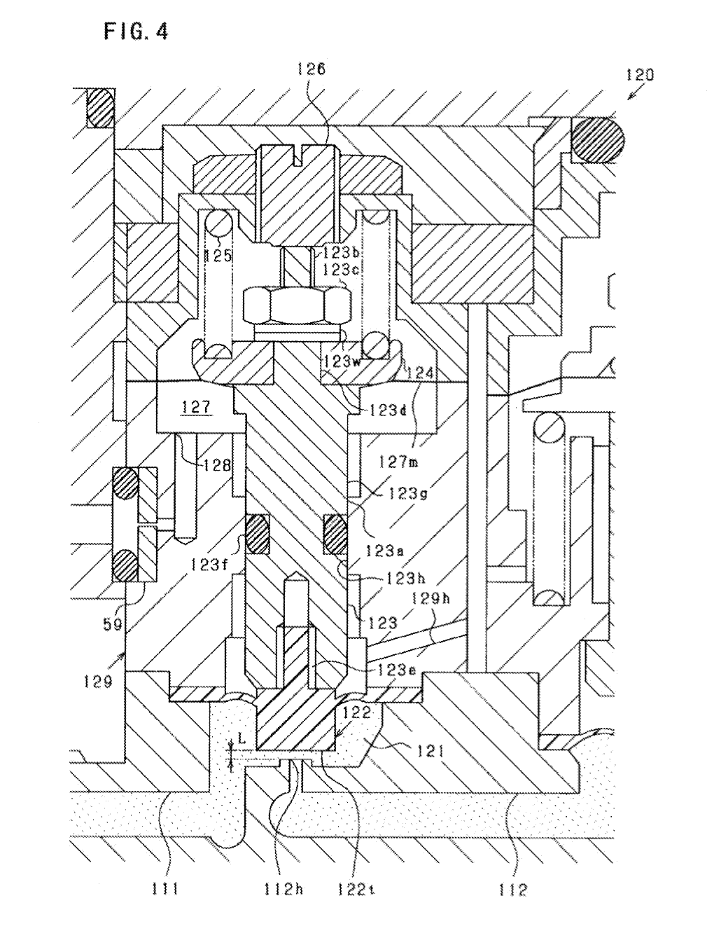

FIG. 2 is a sectional view showing an internal configuration of the liquid chemical discharge valve 100 according to this embodiment. FIG. 3 is an enlarged sectional view showing an internal configuration of the air operated valve 120 in a closed condition. FIG. 4 is an enlarged sectional view showing the internal configuration of the air operated valve 120 in an open condition. The liquid chemical discharge valve 100 includes an internal flow passage 110 for supplying the resist liquid R to the spin coater 60 (see FIG. 1). The air operated valve 120 that controls a flow of the resist liquid R and the suck back device 130 for preventing the resist liquid R from dripping when the air operated valve 120 is closed are connected to the internal flow passage 110 in series.

The internal flow passage 110 includes the inlet side flow passage 111 for supplying the resist liquid R discharged from the pump device 30 to the air operated valve 120, an intermediate flow passage 112 for supplying the resist liquid R discharged from the air operated valve 120 to the suck back device 130, and an outlet side flow passage 113 for supplying the resist liquid R discharged from the suck back device 130 to the liquid chemical discharge nozzle 62. In this embodiment, the inlet side flow passage 111, intermediate flow passage 112, and outlet side flow passage 113 are disposed rectilinearly.

The air operated valve 120 includes a valve chamber 121 that connects the inlet side flow passage 111 to the intermediate flow passage 112, and controls the flow of the resist liquid R through the internal flow passage 110 by opening and closing a connecting hole 112h (see FIGS. 3 and 4) connecting the valve chamber 121 to the intermediate flow passage 112. The air operated valve 120 includes a diaphragm 122 having a contact portion 122t that opens and closes the connecting hole 112h, a valve main body 129 in which a cylinder chamber 127 and an operating air supply port 128 are formed, a piston rod 123, a piston 124, a biasing spring 125, a lift amount limiting mechanism 126, and a membrane 127m that seals the cylinder chamber 127. Note that the connecting hole 112h will also be referred to as a liquid chemical discharge port. A connecting port between the inlet side flow passage 111 and the valve chamber 121 will also be referred to as a liquid chemical supply port. The operating air supply port 128 will also be referred to as an operating gas supply port.

The lift amount limiting mechanism 126 limits a maximum value of a lift amount L adjustably by limiting a movement amount of the piston rod 123. As shown in FIG. 4, the lift amount L is a distance between the contact portion 122t of the diaphragm 122 and the connecting hole 112h, and corresponds to a valve opening of the air operated valve 120. The lift amount limiting mechanism 126 is attached by screwing and can therefore be rotated in order to make fine adjustments thereto. In so doing, individual differences in the liquid chemical discharge valve 100 and so on can be absorbed, and as a result, a steady flow rate can be set in the liquid chemical supply system 90.

Hence, the liquid chemical supply system 90 is configured such that when the discharge pressure of the pump device 30 is set at a predetermined value, a steady discharge amount of the resist liquid R can be adjusted by adjusting the maximum value of the lift amount L using the lift amount limiting mechanism 126. Note that in this embodiment conducted by the present inventor, the maximum value of the lift amount L was set at approximately 0.2 mm

The piston rod 123 is configured as follows. The piston rod 123 includes a columnar piston rod main body 123a having a central axis in a movement direction thereof, a fastening nut 123c, and two washers 123w. An attachment shaft portion 123d to which the piston 124 is attached and a male screw portion 123b are provided on one end of the piston rod main body 123a and formed integrally with the piston rod main body 123a. The piston 124 is attached to the attachment shaft portion 123d, and the resulting component is fastened to the male screw portion 123b by the fastening nut 123c. Meanwhile, a female screw portion 123e for attaching the diaphragm 122 is formed in the piston rod main body 123a.

Note that a gap formed between the male screw portion 123b and the lift amount limiting mechanism 126 when the valve is closed corresponds to a maximum lift amount Lmax (set at approximately 0.2 mm), which is the maximum value of the lift amount L when the valve is open.

The piston rod 123 includes the piston rod main body 123a, which is formed integrally from the female screw portion 123e for attaching the diaphragm 122 to the male screw portion 123b. The male screw portion 123b is configured to contact the lift amount limiting mechanism 126 in response to an increase in the lift amount L. The male screw portion 123b is formed on a straight line sharing a central axis with the piston rod main body 123a and the female screw portion 123e, and is therefore capable of limiting the lift amount L of the diaphragm 122 while maintaining a high degree of rigidity. As a result, excessive vibration occurring when the piston rod 123 bottoms out can be prevented.

The piston rod 123 is attached such that a sliding surface 123g thereof slides through a fitting hole 123h. A gap between the sliding surface 123g of the piston rod 123 and the fitting hole 123h is sealed by an O ring 123f. Operating air leaking from the O ring 123f is discharged via a discharge flow passage 129h. The O ring 123f exhibits greater hysteresis than low-hysteresis Y packing or the like used typically in an air operated valve. In other words, a large difference exists between a static frictional force and a kinetic frictional force of the O ring 123f.

In contravention of typical technical common knowledge, the present inventor has succeeded in suppressing a stick slip phenomenon by sealing the piston rod 123 using the O ring 123f. The stick slip phenomenon is a vibration phenomenon known colloquially as “chatter”, which occurs when a state of static friction (a static state) and a state of kinetic friction (a moving state) are generated repeatedly. The piston rod 123 exhibits great hysteresis due to the seal provided by the O ring 123f, and therefore has a property whereby a state of static friction is unlikely to occur once a state of kinetic friction has been established. In other words, the O ring 123f realizes a property whereby the piston rod 123 is unlikely to stop after starting to move, and therefore the stick slip phenomenon can be suppressed during a valve opening operation and a valve closing operation.

Note, however, that with this property, it is difficult to perform control to stop the piston rod 123 in an intermediate position, and it is therefore technical common knowledge to persons skilled in the art that this property is not suitable for application to a typical air operated valve whose valve opening is to be adjusted. This embodiment has been designed in contravention of typical technical common knowledge, focusing on the fact that even though an air operated valve is used, the steady discharge amount of the resist liquid R is adjusted by adjusting the maximum value of the lift amount L using the lift amount limiting mechanism 126, and therefore the piston rod 123 does not need to be stopped in an intermediate position.

Hence, by employing the O ring 123f in this configuration, the stick slip phenomenon, which is a non-linear phenomenon, is prevented using hysteresis caused by frictional non-linearity (the large difference between the kinetic frictional force and the static frictional force) generated as the piston rod 123 moves. As a result, the air operated valve 120 exhibits a unique characteristic whereby pulsation of the diaphragm 122 as the air operated valve 120 is opened and closed can be suppressed.

The air operated valve 120 is opened and closed by driving the diaphragm 122. The diaphragm 122 is driven by the piston 124 via the piston rod 123. The piston 124 is driven in a direction for increasing the lift amount L using the pressure of the operating air in the interior of the cylinder chamber 127. On the other hand, the piston 124 is biased in a direction for reducing the lift amount L by the biasing spring 125. Note that the piston rod 123, piston 124, biasing spring 125, lift amount limiting mechanism 126, and cylinder chamber 127, which together drive the diaphragm 122, will also be referred to as an actuator unit.

As a result, the piston 124 is operated at an acceleration where a load serving as a difference between a driving force generated by the pressure of the operating air supplied to the cylinder chamber 127 through the operating air supply port 128 and a biasing force of the biasing spring 125, and an inertial force of the piston rod 123, the piston 124, and so on, are counterbalanced.

Operating air is supplied to the operating air supply port 128 from the operating air supply unit 50 via an operating air supply member 57 attached to the air operated valve 120. An operating air supply passage 58 is formed in the operating air supply member 57, and an orifice 59 is formed between the operating air supply passage 58 and the operating air supply port 128. An orifice diameter of the orifice 59 is at a minimum between the operating air supply passage 58 and the operating air supply port 128 such that pulsation in the operating air supplied to the operating air supply port 128 is suppressed.

### (Control of Liquid Chemical Discharge Valve According to Embodiment)

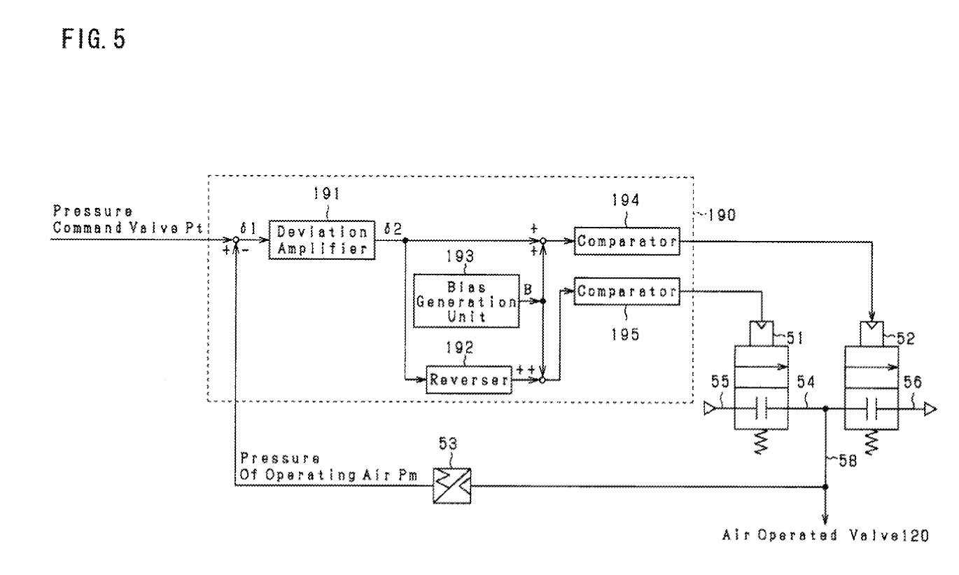

FIG. 5 is a control block diagram of the liquid chemical discharge valve 100 according to this embodiment. The sub-controller 190 controls the supply pressure of the operating air supplied to the air operated valve 120 to approach a pressure command value Pt. This control is performed by continuously manipulating valve openings of the first proportional control valve 51 and the second proportional control valve 52. The controller 10 and the sub-controller 190 will also be referred to as a control unit.

The sub-controller 190 includes a deviation amplifier 191, a bias generation unit 193, a reverser 192, two comparators 194 and 195, and a connector 199 (see FIG. 2) for communicating with and supplying power to the controller 10. The deviation amplifier 191 amplifies a deviation δ1 between the pressure command value Pt and a measured value Pm of the pressure sensor 53 to obtain an amplified value δ2. The comparator 194 compares an added value obtained by adding together the amplified value δ2 and a bias value B with a threshold, and reduces the opening of the second proportional control valve 52 when the added value is larger than the threshold. Meanwhile, the comparator 195 compares an added value obtained by adding together a negative amplified value δ2 reversed (sign-reversed) by the reverser 192 and the bias value B with a threshold, and reduces the opening of the first proportional control valve 51 when the added value is larger than the threshold.

Thus, the first proportional control valve 51 and the second proportional control valve 52 are operated such that the measured value Pm of the pressure sensor 53 approaches the pressure command value Pt. The bias generation unit 193 is capable of setting all control signals input into the two comparators 194 and 195 at positive values and adjusting a discharge speed during pressure manipulation by the first proportional control valve 51 and second proportional control valve 52. Note that the openings of the first proportional control valve 51 and the second proportional control valve 52 will also be referred to respectively as a first opening and a second opening.

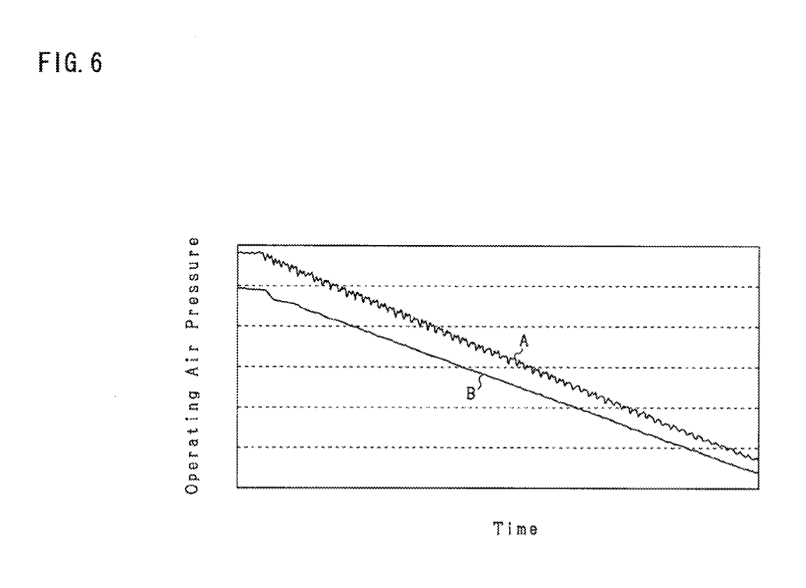

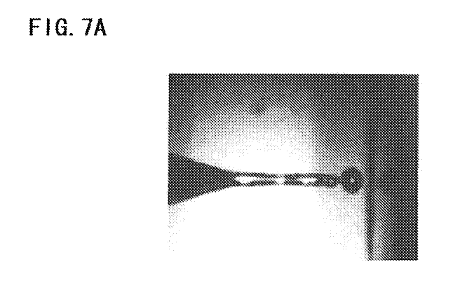

FIG. 6 is a graph showing a comparison between operating air pressures of the liquid chemical discharge valve 100 according to this embodiment and a liquid chemical discharge valve according to a comparative example. The liquid chemical discharge valve according to the comparative example is a valve in which a pair of solenoid valves (not shown) corresponding to the first proportional control valve 51 and the second proportional control valve 52 are ON/OFF valves which are switched from proportional control valves, and valve opening control is performed through pulse width modulation. As is evident from a curve A shown in the drawing, with the liquid chemical discharge valve according to the comparative example, pulsation occurs in the operating air as the pair of ON/OFF valves (not shown) are opened and closed. The operating air supply unit 50 according to this embodiment, on the other hand, manipulates the supply pressure of the operating air by continuously adjusting the openings of the first proportional control valve 51 and the second proportional control valve 52, and therefore, as shown by a curve B, pulsation caused by pulse width modulation does not occur. As a result, the supply pressure of the operating air can be manipulated continuously.

Meanwhile, the stick slip phenomenon is prevented from occurring as the piston rod 123 moves by employing the O ring 123f, as described above, and therefore pulsation of the diaphragm 122 as the air operated valve 120 opens and closes can also be suppressed. The operating air supply unit 50 supplies operating air to the air operated valve 120 via the orifice 59, and therefore pulsation occurring during control (a correction operation) in the vicinity of the pressure command value Pt, which serves as a target value, can also be suppressed dramatically.

Hence, the liquid chemical discharge valve 100 is capable of suppressing pulsation of the diaphragm 122. When the diaphragm 122 pulsates, pressure oscillation that causes the liquid chemical to pulsate is exerted on the liquid chemical in the interior of the valve chamber 121, and therefore, by suppressing pulsation of the diaphragm 122, pulsation in the liquid chemical discharged from the liquid chemical discharge valve 100 is also suppressed.

Hence, the present inventor has succeeded in suppressing pulsation in the liquid chemical during the opening and closing operations of the liquid chemical discharge valve 100 by implementing countermeasures from various viewpoints, namely (1) suppressing pulsation occurring during control of the operating air pressure, (2) reducing pulsation caused by the orifice 59 in the operating air supply flow passage, and (3) forestalling the stick slip phenomenon in the piston rod 123. The present inventor has also realized a configuration for suppressing pulsation in the liquid chemical during steady discharge of the liquid chemical by stopping the diaphragm 122 using the lift amount limiting mechanism 126.

### (Mechanism for Stabilizing Small-Amount Supply of Liquid Chemical by Suppressing Pulsation in Liquid Chemical)

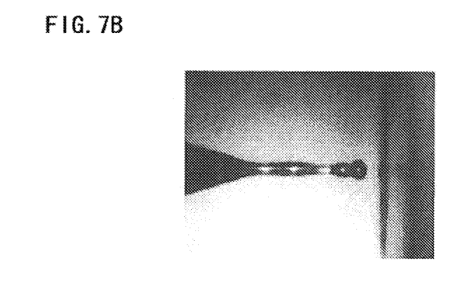

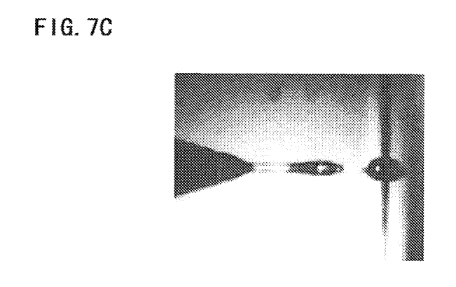

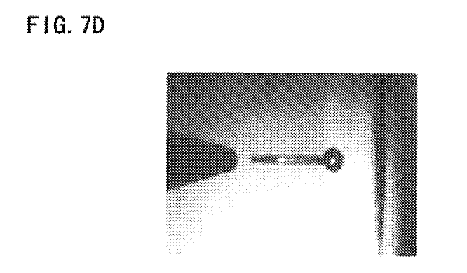

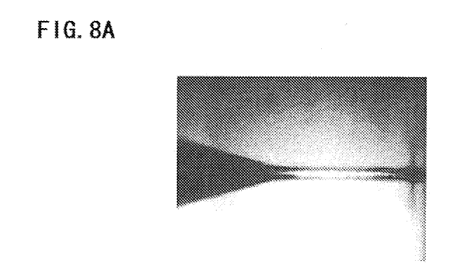

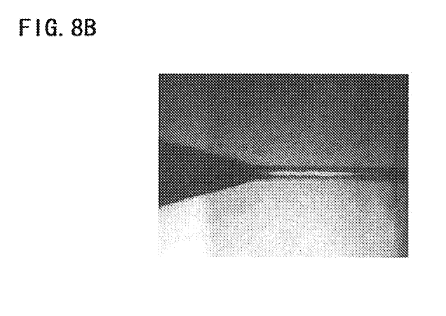

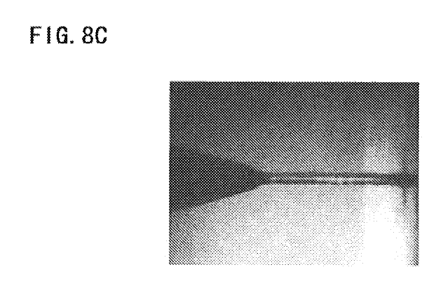

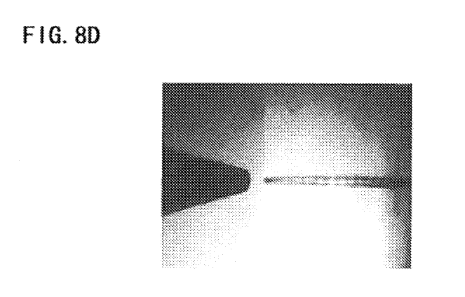

FIG. 7 is a view showing a liquid chemical discharge condition photographed by a high-speed camera according to a comparative example. FIG. 8 is a view showing a liquid chemical discharge condition photographed by a high-speed camera according to this embodiment. FIG. 7A shows a condition at the start of the closing operation of the liquid chemical discharge valve according to the comparative example, while FIGS. 7B, 7C and 7D show sequential stages occurring until a supply flow rate of the liquid chemical reaches zero (the liquid is cut off). FIG. 8A shows a condition at the start of the closing operation of the liquid chemical discharge valve according to this embodiment, while FIGS. 8B, 8C and 8D show sequential stages occurring until the supply flow rate of the liquid chemical reaches zero (the liquid is cut off).

As is evident from FIG. 7, in the liquid chemical discharge condition according to the comparative example, droplet formation progresses as the supply flow rate of the liquid chemical approaches zero, thereby disturbing the flow of the liquid chemical. According to analysis conducted by the present inventor, disturbances in the liquid chemical flow are caused by surface tension in the resist liquid R. As is evident from FIG. 8, in the liquid chemical discharge condition according to this embodiment, on the other hand, droplet formation is suppressed even when the supply flow rate of the liquid chemical approaches zero, and therefore substantially no disturbances occur in the flow of the liquid chemical.

The resist liquid R is drip-fed at high speed, making it difficult to identify with the naked eye the droplet formation that occurs in the liquid chemical in the comparative example. Accordingly, research into this droplet formation by persons skilled in the art has not progressed. On the other hand, when surface tension is identified, it is customary and technical common knowledge to adjust the characteristics of the resist liquid R in order to reduce the surface tension. However, the present inventor has established through experiment that droplet formation due to surface tension is advanced by disturbances occurring during discharge of the liquid chemical, and that a main cause of these disturbances is pulsation of the diaphragm 122. In other words, the present inventor has confirmed through experiment that by suppressing pulsation of the diaphragm 122, droplet formation due to surface tension can be suppressed.

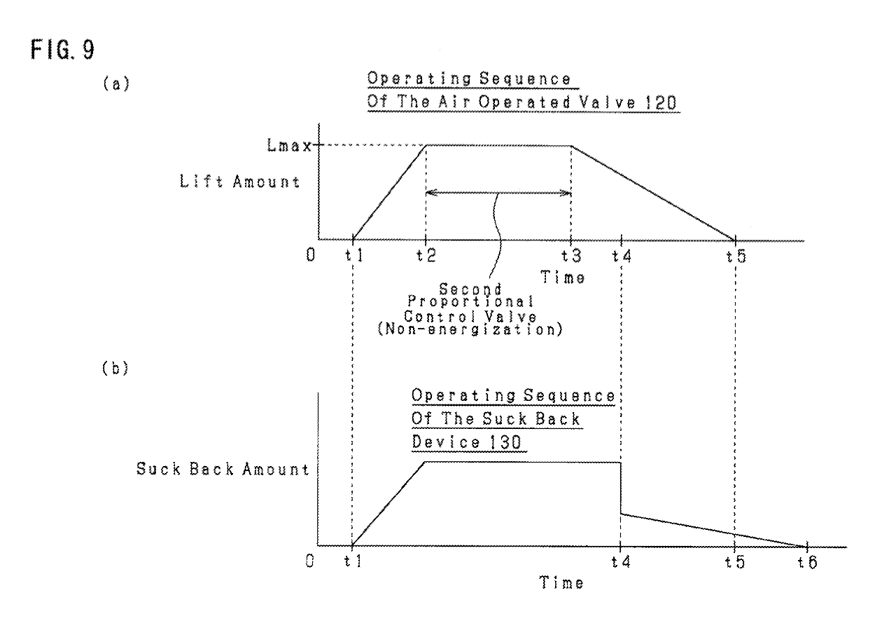

FIG. 9 is a time chart showing operating sequences of the air operated valve 120 and the suck back device 130. The controller 10 (see FIG. 1) issues a command to the liquid chemical discharge valve 100 to perform a valve opening operation. The valve opening operation command is issued by raising the pressure command value Pt applied to the liquid chemical discharge valve 100. In other words, the controller 10 increases the pressure command value Pt such that from a time t1, the lift amount L increases from zero at a constant speed.

As a result of this valve opening operation, the air operated valve 120 can make the liquid chemical start to flow smoothly without rapid pressure variation. The valve opening operation according to this embodiment is achieved by adjusting the lift amount from a closed valve condition to an open valve condition, and therefore, as described above, pulsation in the lift amount during lift amount control in the vicinity of the target value and during a transition between a state of static friction and a state of kinetic friction does not occur.

Meanwhile, the controller 10 causes the suck back device 130 to begin a setup process at the time t1. The setup process is a preparatory process required to perform a suck back process for preventing dripping when the air operated valve 120 is closed. The suck back process is a process for preventing dripping by causing a diaphragm 133 to withdraw from a suck back valve chamber 131, thereby expanding the suck back valve chamber 131 such that the liquid chemical is sucked back from the liquid chemical discharge nozzle 62 side. The preparatory process is a process for reducing the suck back valve chamber 131 by moving the diaphragm 133 to the suck back valve chamber 131 side in advance.

In the air operated valve 120, the lift amount L reaches the maximum lift amount Lmax at a time t2, whereby the lift amount L is stabilized (fixed). As a result of this closed valve maintenance operation, the air operated valve 120 can supply the liquid chemical to the liquid chemical discharge nozzle 62 with accuracy and stability at a preset liquid chemical flow rate. At this time, the position of the diaphragm 122 is constrained by the lift amount limiting mechanism 126, and therefore the lift amount L is also fixed mechanically.

Note that since the lift amount L is also fixed mechanically, a power consumption of the liquid chemical discharge valve 100 can be reduced by stopping the second proportional control valve 52. In so doing, heat generation in the liquid chemical discharge valve 100 can be suppressed. Meanwhile, depending on an operating manner, the first proportional control valve may be operated in a closed condition through non-energization or controlled to an open condition by a small lift amount. As a result, the power consumption and heat generation can be suppressed even further. The reason for this is that the open valve maintenance operation is performed in a bottomed out condition, and therefore the supply pressure of the operating air may pulsate.

The controller 10 (see FIG. 1) issues a command to the liquid chemical discharge valve 100 to perform a valve closing operation. The valve closing operation command is issued by lowering the pressure command value Pt applied to the liquid chemical discharge valve 100. When the pressure command value Pt is lowered, the lift amount L decreases from the maximum lift amount Lmax at a constant speed from a time t3.

As a result of the valve closing operation, the air operated valve 120 can stop the flow of the liquid chemical without generating an excessive water hammer phenomenon. The valve closing operation according to this embodiment is achieved by adjusting the lift amount from the open valve condition to the closed valve condition, and therefore pulsation in the lift amount during lift amount control in the vicinity of the target value and during a transition between a state of static friction and a state of kinetic friction does not occur.

The controller 10 causes the suck back device 130 to begin the suck back process at a time t4. The time t4 is a timing close to a start time (a time t3) of the valve closing operation of the liquid chemical discharge valve 100. The start time (the time t4) of the suck back process may be set within a predetermined range on either side of the start time (the time t3) of the valve closing operation of the liquid chemical discharge valve 100. The suck back process is a process for suctioning the resist liquid R rapidly at the time t4 so that the liquid chemical is sucked back from the liquid chemical discharge nozzle 62. As a result, the liquid is cut off favorably, and by suctioning the liquid chemical slowly until a time t6, dripping from the liquid chemical discharge nozzle 62 can be prevented.

Hence, according to this embodiment, pulsation in the liquid chemical can be reduced dramatically during all operations of the liquid chemical discharge valve 100, and as a result, disturbances in the liquid chemical flow can be suppressed. Therefore, a discharge flow rate of the resist liquid R can be reduced without weakening the surface tension of the resist liquid R and while suppressing droplet formation generated by the surface tension due to disturbances in the liquid chemical flow.

The first means shown in summary of the invention may be modified as follows.

A third means is the liquid chemical discharge valve according to the first means in which the actuator unit includes a piston for driving the contact portion in accordance with the supply pressure of the operating gas, and a cylinder formed with a cylinder chamber that houses the piston, and the piston includes a sliding portion that seals the cylinder chamber using an O ring.

In this liquid chemical discharge valve, the piston includes the sliding portion that seals the cylinder chamber using the O ring, and therefore the piston slides relative to the cylinder chamber with greater hysteresis than Y packing or the like typically used in a liquid chemical discharge valve. In other words, this sliding motion generates a friction condition in which a difference between a kinetic frictional force and a static frictional force is extremely large, and therefore, once a state of kinetic friction is established during the valve closing operation, a state of static friction is unlikely to be established thereafter.

According to the typical technical common knowledge of persons skilled in the art at the time of filing, such a characteristic is typically undesirable when constructing a liquid chemical discharge valve that controls a valve opening by manipulating a piston position. With this configuration, however, stable valve opening and valve closing operations can be realized in a state of kinetic friction while preventing establishment of a state of static friction, and therefore the stick slip phenomenon can be forestalled. As a result, disturbances in the liquid chemical flow due to droplet formation can be suppressed.

A fourth means is the liquid chemical discharge valve according to the first or third means in which the liquid chemical is a resist liquid used in a photolithography process.

In a photolithography process, a high quality, extremely thin film must be formed evenly on a flat surface, and efficient use of a resist liquid R is also desirable. It is therefore desirable to drip-feed the resist liquid onto a wafer at a very low flow rate with stability and without causing droplets to form. Hence, dramatic effects are achieved with th this means.

A fifth means is the liquid chemical supply system according to the second means in which the second proportional control valve enters a closed condition when not energized, and the control unit sets the second proportional control valve in a non-energized condition during the open valve maintenance operation.

In this liquid chemical supply system, the control unit closes the second proportional control valve by setting the second proportional control valve in a non-energized condition during the open valve maintenance operation so that the supply pressure of the operating gas can be kept high. In the open valve maintenance operation, the maximum lift amount is maintained by the lift amount limiting unit simply by keeping the supply pressure of the operating gas high, and therefore the open valve maintenance operation is realized in a condition where a power supply to the second proportional control valve is stopped. As a result, a reduction in power consumption and a reduction in increases in the temperature of the liquid chemical discharge valve can be achieved.

Note that depending on an operating manner, the first proportional control valve may be operated in a closed condition through non-energization or controlled to an open condition by a small lift amount. As a result, power consumption and heat generation can be suppressed even further. The reason for this is that the open valve maintenance operation is performed in a bottomed out condition, and therefore the supply pressure of the operating air may pulsate.

Note that the embodiment is not limited to the content described above, and may be implemented as follows, for example.

(1) In the above embodiment, countermeasures are implemented from various viewpoints, namely (1) suppressing pulsation occurring during control of the operating air pressure, (2) reducing pulsation caused by the orifice 59 in the operating air supply flow passage, and (3) forestalling the stick slip phenomenon in the piston rod 123. However, it is not necessary to implement all of these countermeasures as long as at least one of the countermeasures is implemented.

(2) In the above embodiment, an example in which the resist liquid R is applied as a liquid chemical to the semiconductor wafer W during photolithography was described, but the process and the type of liquid chemical are not limited thereto, and the present invention may be applied to any system for supplying a liquid chemical.

(3) In the above embodiment, driving is performed using operating air, but as long as driving is performed using a typical operating gas, nitrogen gas, for example, may be used instead.

1. A liquid chemical discharge valve for supplying a liquid chemical onto a rotating wafer, comprising:
a valve main body having a valve chamber formed with a liquid chemical supply port to which the liquid chemical is supplied and a liquid chemical discharge port through which the liquid chemical is discharged;
a diaphragm valve having a contact portion for varying a flow condition between the liquid chemical supply port and the liquid chemical discharge port by manipulating a lift amount, which is a distance between the contact portion and one of the liquid chemical supply port and the liquid chemical discharge port, between a closed valve condition and a maximum lift amount;
an operating gas supply unit having a first proportional control valve capable of continuously adjusting a first opening in order to manipulate a supply amount of an operating gas, a second proportional control valve capable of continuously adjusting a second opening in order to manipulate a discharge amount of the operating gas, and an operating gas supply port connected to an intermediate flow passage that connects the first proportional control valve to the second proportional control valve; and
an actuator unit for driving the contact portion in accordance with a supply pressure of the operating gas supplied from the operating gas supply port, to thereby manipulate the lift amount,
wherein the actuator unit includes a lift amount limiting unit for limiting the maximum lift amount adjustably.

2. The liquid chemical discharge valve according to claim 1, wherein the actuator unit includes a piston for driving the contact portion in accordance with the supply pressure of the operating gas, and a piston rod to which the piston is attached, wherein
the diaphragm valve is attached to the piston rod, and
the lift amount limiting unit is configured to limit the maximum lift amount adjustably by limiting a movement amount of the piston rod.

3. The liquid chemical discharge valve according to claim 2, wherein the piston rod is configured to contact the lift amount limiting unit to limit the limit the movement amount of the piston rod.

4. The liquid chemical discharge valve according to claim 3, wherein a gap formed between the piston rod and the lift amount limiting unit when the diaphragm valve is in the closed valve sate corresponds to the maximum lift amount.

5. The liquid chemical discharge valve according to claim 1, wherein the maximum lift amount is set at 0.2 mm.

6. The liquid chemical discharge valve according to claim 1, wherein the actuator unit includes a piston for driving the contact portion in accordance with the supply pressure of the operating gas, and a cylinder formed with a cylinder chamber that houses the piston, and
the piston includes a sliding portion that seals the cylinder chamber using an O ring.

7. The liquid chemical discharge valve according to claim 6, further comprising:
a discharge flow passage for discharging the operating air leaking from the O ring.

8. The liquid chemical discharge valve according to claim 1, wherein the liquid chemical is a resist liquid used in a photolithography process.

9. A liquid chemical supply system comprising:
the liquid chemical discharge valve according to claim 1; and
a control unit for controlling a supply amount of the liquid chemical by continuously adjusting the first opening and the second opening so as to manipulate the supply pressure of the operating gas,
wherein the control unit is configured to discharge the liquid chemical intermittently by causing the actuator unit to execute, in sequence, a closed valve maintenance operation for maintaining the closed valve condition, a valve opening operation for increasing the lift amount from the closed valve condition to the maximum lift amount, an open valve maintenance operation for maintaining the lift amount at the maximum lift amount, and a valve closing operation for reducing the lift amount from the maximum lift amount to the closed valve condition.

10. The liquid chemical supply system according to claim 9, wherein the second proportional control valve is configured to enter a closed condition when not energized, and
the control unit is configured to set the second proportional control valve in a non-energized condition during the open valve maintenance operation.
